(19) United States
(12) Patent Application Publication
(10) Pub. No.: US 2013/0070693 A1
(43) Pub. Date: Mar. 21, 2013

(54) METHOD AND APPARATUS FOR TRANSMITTING AND RECEIVING MULTIPLE DATA TRANSMISSION RESULT

(71) Applicants: Kibum Kwon, Ansan-si (KR); Kitae Kim, Suwon-si (KR)

(72) Inventors: Kibum Kwon, Ansan-si (KR); Kitae Kim, Suwon-si (KR)

(73) Assignee: PANTECH CO., LTD., Seoul (KR)

(21) Appl. No.: 13/521,581

(22) PCT Filed: Dec. 27, 2010
(86) PCT No.: PCT/KR2010/009377

§ 371 Date: Jul. 11, 2012

(30) Foreign Application Priority Data
Jan. 12, 2010 (KR) 10-2010-0002834

(51) Int. Cl. H04W 72/04

(52) U.S. Cl. CPC H04W 72/04
USPC 370/329

(57) ABSTRACT

A method and an apparatus for transmitting and receiving multiple data transmission result, the apparatus comprises: a receiver in which a base station receives two or more uplink subframes that include independent data from a terminal; a reception verifier which verifies the independent data received from the receiver; a response data generator which generates a verification result for the independent data as response data; a signal generator which generates a downlink subframe by storing first information of the response data in a first section of a control area, and by storing second information of the response data in a field, which is not changed for a certain period of time, within a second section of the control area that is distinguished from the first section; and a transmitter which transmits the downlink subframe.

### CROSS-REFERENCE RELATED APPLICATIONS

This application is the National Stage Entry of International Application PCT/KR2010/009377, filed on Dec. 27, 2010, and claims priority from and the benefit of Korean Patent Application No. 10-2010-0002834, filed on Jan. 12, 2010, both of which are herein incorporated by reference for all purposes as if fully set forth herein.

### BACKGROUND

1. Field

The present disclosure relates to a method and apparatus for performing multiple transmission and reception of a data transmission result.

2. Discussion of the Background

In a mobile communication system, a user equipment (UE) and a base station (BS) may check received data so as to determine whether data transmission is performed without an error, may transmit and receive a data transmission result (Acknowledge (ACK)/Negative Acknowledge (NACK)), and may provide a mechanism for retransmitting data which has an error during the transmission.

In the mobile communication system, the BS may allocate resources included in a predetermined frequency band to the UE, and the UE and the BS may perform transmission and reception of data within the allocated resources.

Since resource allocation is limited, an efficiency of resources may need to be taken into consideration even in a process of transceiving a verification result on the received data

### SUMMARY

Therefore, the present invention has been made in view of the above-mentioned problems, and an aspect of the present invention is to provide a method that enables a base station (BS) to unitarily transmit results on a plurality of pieces of received data to a user equipment (UE) using limited resources when transmission and reception resources between the BS and the UE are different, for example, when data is transmitted and received by forming a plurality of layers in an SU-MIMO or by utilizing a plurality of component carriers (CCs).

In accordance with an aspect of the present invention, there is provided a base station (BS), including: a receiver to receive, by the BS from a user equipment (UE), two or more uplink (UL) subframes including independent data; a reception verifier to verify the independent data received by the receiver; a response data generator to generate a verification result on the independent data as response data; a signal generator to store first information of the response data in a first section in a control area, and to store second information of the response data in a field that is not changed during a predetermined period and belongs to a second section that is distinguished from the first section in the control area, so as to generate a downlink (DL) subframe; and a transmitter to transmit the DL subframe.

In accordance with another aspect of the present invention, there is provided a UE, including: a receiver to receive, from a BS, a DL subframe including information associated with UL resource allocation; a signal decoder to extract the uplink resource allocation information from the received DL subframe; a UL subframe generator to generate a UL subframe based on the UL resource allocation information; and a transmitter to transmit, to the BS, two or more UL subframes including independent data through the allocated uplink resource, and the receiver receives, from the BS, a DL subframe including response data corresponding to a verification result on the two or more UL subframes; and the signal decoder extracts first information of the response data from a first section of a control area of the DL subframe, and extracts second information of the response data from a field that is not changed during a predetermined period and belongs to a second section that is distinguished from the first section in the control area.

In accordance with another aspect of the present invention, there is provided a method of performing multiple transmission of a data transmission result, the method including: receiving, from a UE, two or more UL subframes including independent data, and verifying the independent data; generating a verification result on the independent data as response data, storing first information of the response data in a first section of a control area, and storing second information of the response data in a field that is not changed during a predetermined period and belongs to a second section that is distinguished from the first section in the control area, so as to generate a DL subframe; and transmitting the DL subframe.

In accordance with another aspect of the present invention, there is provided a method of performing multiple reception of a data transmission result, the method including: receiving, from a BS, a DL subframe including information associated with UL resource allocation; transmitting, to the BS, two or more UL subframes including independent data through use of the allocated UL resources; receiving, from the BS, a DL subframe including response data corresponding to a verification result on the two or more UL subframes; and extracting first information of the response data from a first section of a control area of the received DL subframe, and extracting second information of the response data from a field that is not changed during a predetermined period and belongs to a second section that is distinguished from the first section.

### BRIEF DESCRIPTION OF THE DRAWINGS

FIG. 1 is a diagram illustrating a process in which a base station (BS) transmits an ACK/NACK through use of a PHICH in an LTE system;

FIG. 2 is a diagram illustrating a process that allocates PHICH resources in an SU-MIMO or a network of a carrier aggregation (CA).

FIG. 3 is a diagram illustrating a process that allocates PHICH resources in an SU-MIMO according to an embodiment of the present invention;

FIG. 4 is a diagram illustrating a process that allocates PHICH resources in a CA according to an embodiment of the present invention;

FIG. 5 is a diagram illustrating a process that updates a DMRS-CS according to an embodiment of the present invention;

FIG. 6 is a diagram illustrating a configuration of a BS according to an is embodiment of the present invention;

FIG. 7 is a diagram illustrating a configuration of a user equipment (UE) according to an embodiment of the present invention;

FIG. 8 is a diagram illustrating a process that transmits and receives data in a BS according to an embodiment of the present invention; and

FIG. 9 is a diagram illustrating a process that transmits and receives data in a UE according to an embodiment of the present invention.

110: eNB
150: UE
390, 490: configuration of a control area
600: configuration of a BS
700: configuration of a UE

### DETAILED DESCRIPTION OF EXEMPLARY EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

Embodiments of the present invention will be described based on a wireless communication network, and operations performed in the wireless communication network may be performed in a process in which a system that manages the corresponding wireless communication network, for example, a base station (BS), controls the network and transceives data, or may be performed in a user equipment (UE) that is coupled with the corresponding wireless network.

The wireless communication system may be widely installed so as to provide various communication services, such as a voice service, packet data, and the like. The wireless communication system may include a UE and a BS.

Throughout the specifications, the UE may be an inclusive concept indicating a user terminal utilized in a wireless communication, including a UE in WCDMA, long term evolution (LTE), HSPA, and the like, and a mobile station (MS), a user terminal (UT), a subscriber station (SS), a wireless device, and the like in GSM.

The BS or a cell may refer to a fixed station where communication with the UE is performed, and may also be referred to as a Node-B, an evolved Node-B (eNB), a base transceiver system (BTS), an access point, and the like.

The BS or the cell may be construed as an inclusive concept indicating a portion of an area covered by a base station controller (BSC) in CDMA, a Node B in WCDMA, and the like, and the concept may include various coverage areas, such as a megacell, macrocell, a microcell, a picocell, a femtocell, and the like.

In the specifications, the UE and the BS are used as two inclusive transceiving subjects to embody the technology and technical concepts described in the specifications, and may not be limited to a predetermined term or word.

A multiple access scheme applied to the wireless communication system may not be limited. The wireless communication system may utilize varied multiple access schemes, such as Code Division Multiple Access (CDMA), Time Division Multiple Access (TDMA), Frequency Division Multiple Access (FDMA), Orthogonal Frequency Division Multiple Access (OFDMA), OFDM-FDMA, OFDM-TDMA, OFDM-CDMA, and the like.

Uplink (UL) transmission and downlink (DL) transmission may be performed based on a time division duplex (TDD) scheme that performs transmission based on different times, or based on a frequency division duplex (FDD) scheme that performs transmission based on different frequencies.

An embodiment of the present invention may be applicable to resource allocation in an asynchronous wireless communication scheme that is advanced through GSM, WCDMA, and HSPA, to be LTE and LTE-advanced, and may be applicable to resource allocation in a synchronous wireless communication scheme that is advanced through CDMA and CDMA-2000, to be UMB. Embodiments of the present invention may not be limited to a specific wireless communication scheme, and may be applicable to all technical fields to which a technical idea of the present invention is applicable.

In an OFDM/OFDMA based wireless communication system that uses a single component carrier (CC) or a plurality of CCs according to embodiments of the present invention, a BS may transmit an acknowledgement (ACK)/negative acknowledgement (NACK) so as to inform a UE of whether an error occurs in information received from the UE or whether reception is completed. To transmit an ACK/NACK, resources may be allocated to a physical hybrid ARQ indicator channel (PHICH). When an amount of data transmitted by the UE increases, the BS may transmit response information associated with received data within a limited resource area.

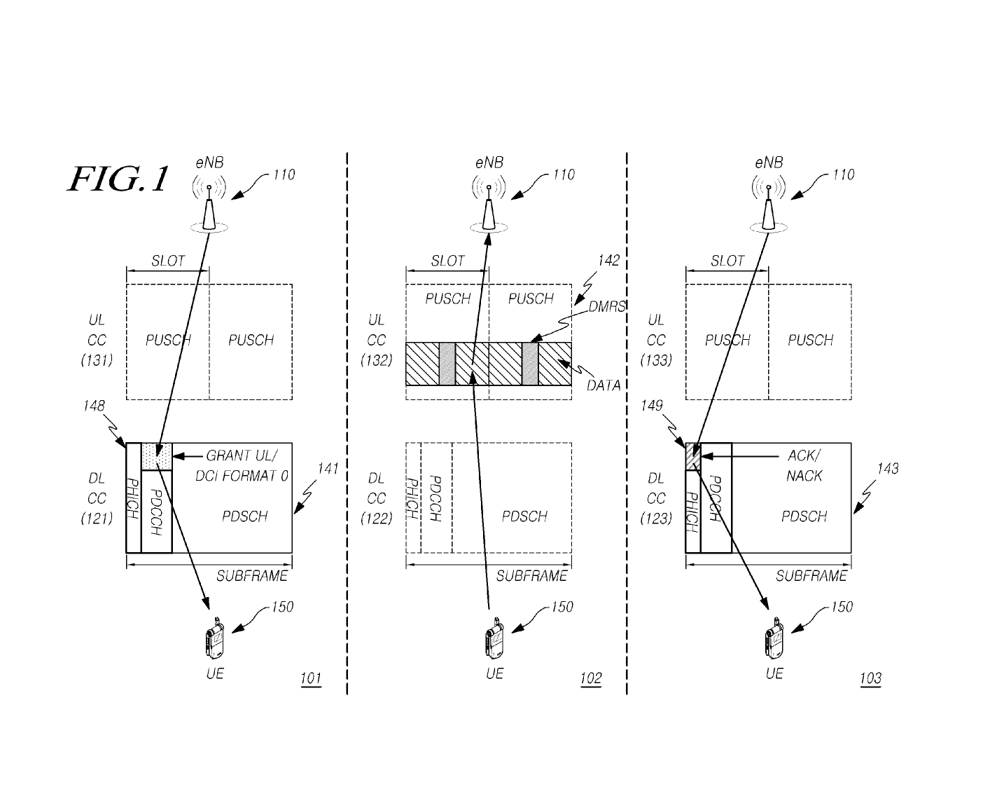

To describe the above process, a process that transmits and receives ACK/NACK information in an existing LTE system is illustrated as shown in FIG. 1.

FIG. 1 illustrates a process in which a BS transmits an ACK/NACK through use of a PHICH in an LTE system.

The PHICH defined in LTE may enable the BS, that is, an eNB, to transmit, through a DL channel, whether a PUSCH is appropriately received, so that the UE may be aware of whether the PUSCH transmitted through a UL is appropriately received.

101 may show a process of setting the UE so that the UE is granted a UL and uses PUSCH resources.

In a process that grants the UL, an eNB 110 sets a downlink control information (DCI) format to 0 in a physical downlink control channel (PDCCH) of a DL CC 121, and a UE 150 sets resource allocation information in the DCI format so that the UE 150 uses the UL. A subframe 141 including the resource allocation information may be transmitted to the UE 150. The DCI format 0 may include resource allocation information and 3-bit demodulation reference signal cyclic shift (DMRS-CS) information. The resource allocation information may be information indicating which physical resource block (PRB) is allocated as resources of a UL in an actually used frequency domain. Accordingly, the UE 150 may be aware of a lowest PRB index of the allocated PUSCH. A DMRS may be information that is included in the middle of the PUSCH allocated to the UE 150, and may be a reference signal to enable channel estimation with respect to data transmitted from the UE 150 to the eNB 110.

A base sequence allocated to the DMRS may be the same, and DMRS-CSDMRS-CS information may be transmitted to minimize interference between DMRSs in an adjacent cell or in the same cell during a phase transformation.

In 101, the UE 150 may be granted a UL. The UE may be aware of the PUSCH resources that the UE is actually assigned with, through use of the DCI format 0 148 of the received subframe 141, and may allocate data and the DMRS to the PUSCH through use of 3-bit DMRS-CS. Accordingly, like 102, the UE 150 may allocate data to be transmitted to the PUSCH resources to a ULCC 132, and may transmit, to the eNB 110, a subframe 142 to which the DMRS is mapped in a few times in a slot.

In 102, the eNB 110 may receive the subframe 142 through the ULCC 132. The eNB 110 may determine whether received information is correctly received without an error. The eNB 110 may inform the UE 150 of no error in the received information, and when an error exists in the received information, the eNB 110 may transmit an ACK or a NACK to inform the UE 110 of the error. The transmission process is illustrated in 103.

103 shows a process in which the eNB 110 includes information associated with whether an error exists in the subframe received from the ULCC 132 in the PHICH for transmission. To inform the UE 150 of whether an error occurs in the reception of a PUSCH through use of an ACK/NACK, the eNB 110 may set an ACK or a NACK in a PHICH as shown in 149, and may transmit the subframe 143. In this example, to perform mapping of resources to the PHICH, a lowest PRB index in the DCI format 0 that has been transmitted to the UE and the 3-bit DMRS-CS may be used. In FIG. 1, the UE 150 may transmit the PUSCH by granting a UL once, and may receive a single PHICH in response to the transmission.

The PHICH resource mapping may be performed based on a PHICH group index and a PHICH sequence index. The PHICH sequence index may be an index of a sequence that is multiplexed to a single PHICH group index. In a case of a normal cyclic prefix (CP), up to 8 PHICH sequences may be multiplexed in a single group. The PHICH sequence may use an orthogonal code sequence.

PHICH resource allocation resources that transmit an ACK/NACK of the corresponding PUSCH may be determined. Two factors directly associated with the PHICH resource allocation may be i) a lowest index PRB of the UL resource allocation and ii) a 3-bit UL DMRS CS associated with the PUSCH transmission. The information may be included in the DCI format 0 that the UE receives.

A process of determining the PHICH resources may be performed as follows.

First, a process of identifying PHICH resources may be calculated from the PHICH group index and the PHICH sequence index.

PHICH index: Index_Pair (n_{PHICH}^{group}, n_{PHICH}^{seq})

N_{PHICH}^{group}=(I_{PRB}_{_{—}}_{RA}^{lowest}^{_{—}}^{index}+n_{DMRS})mod N_{PHICH}^{group}+I_{PHICH}N_{PHICH}^{group}

n_{PHICH}^{seq}=(└I_{PRB}_{_{—}}_{RA}^{lowest}^{_{—}}^{index}/N_{PHICH}^{group}┘+n_{DMRS})mod 2N_{SF}^{PHICH}

n_{PHICH}^{group}: PHICH group index

n_{PHICH}^{seq}: PHICH sequence index

n_{DMRS}: Cyclic shift of a DMRS field of a most recently received DCI format 0

N_{SF}^{PHICH}: Size of spreading factor used in PHICH modulation (4 for Normal CP and 2 for extended CP)

I_{PRB}_{_{—}}_{RA}^{lowest}^{_{—}}^{index}: Lowest PRB index corresponding to PUSCH transmission

N_{PHICH}^{group}: Number of PHICH groups

I_{PHICH}: When PUSCH transmission subframe n of which TDD UL/DL setting is 0 is 4 or 9, 1, and 0 for other cases

Mapping value of n_{DMRS} may be shown in Table 1.

TABLE 1
Mapping value of n_{DMRS}

| Cyclic shift for DMRS field | |
|---|---|
| in DCI format 0 | n_{DMRS} |
| 000 | 0 |
| 001 | 1 |
| 010 | 2 |
| 011 | 3 |
| 100 | 4 |
| 101 | 5 |
| 110 | 6 |
| 111 | 7 |

To determine a number of the PHICH groups, a number of DL RBs, for example, 50 RBs in 10 MHz, and a number obtained from an upper layer (N_{g}){⅕, ½, 1, and 2} may be used.

$${N}_{PHICH}^{group} = \{ \begin{matrix}⌈ {N}_{g} ( {N}_{RB}^{DL} / 8 ) ⌉ \text{:} Normal C P \\ 2 \cdot ⌈ {N}_{g} ( {N}_{RB}^{DL} / 8 ) ⌉ \text{:} Extended C P\end{matrix} \\ {N}_{g} \text{:} \{ 1 / 5 , 1 / 2 , 1 , 2 \} , \\ {N}_{RB}^{DL} \text{:} number of D L R Bs$$

Through the above, the number of PHICH groups may be briefly calculated. when a system bandwidth is 10 MHz (50 RBs), the number N_{g} obtained from the upper layer is 2, a normal CP is used, and a size of a spreading factor used in PHICH modulation is 4, the number of PHICH groups is 4.

Therefore, when the UE transmits a PUSCH by granting a single UL, the UE may receive only a single PHICH. It is because the lowest index PRB of the UL resource allocation and the 3-bit UL DMRS-CS are included in the DCI format 0, and the information may be directly associated with the PHICH resource allocation.

As described in 103, LTE/LTE-A systems may include an ACK/NACK associated with UL PHSCH transmission allocated for each UE in a DL PHICH 149 for transmission.

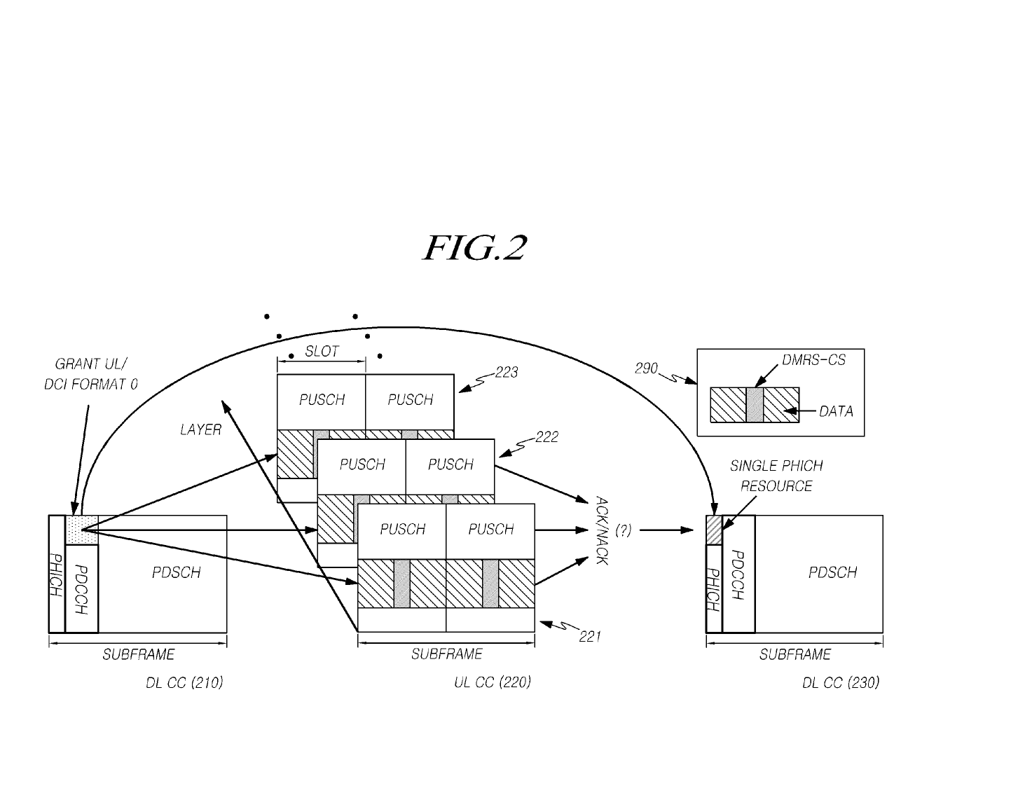

In a UL single-user multiple input multiple output (SU-MIMO) and a carrier is aggregation (CA) environment that uses a plurality of CCs, a PUSCH may be transmitted and an eNB may allocate a plurality of ACKs/NACKs to limited PHICHs for transmission and thus, PHICH resources may be insufficient. However, when the PHICH resources are increasingly allocated to overcome the insufficiency of the PHICH resources, existing control area resources may become insufficient, which will be described with reference to FIG. 2.

FIG. 2 illustrates a process that allocates PHICH resources in an SU-MIMO or a network of a CA.

Through a UL SU-MIMO, a time-frequency resource indicated by a single DCI format 0 may be spatially extended and used. A UE may form multiple layers and may transmit resources in a space for each layer as independent data. In FIG. 2, an eNB may grant a UL to the UE through a DLCC 210, and the UE may transmit data through a plurality of layers 221, 222, and 223 as shown in 220. A DMRS included in a PUSCH is as shown in 290. In this example, to transmit an ACK/NACK associated with data of a PUSCH received through a plurality of layers, corresponding PHICH resources may need to be allocated. Resources allocated to a PHICH as shown in 230 may have a limit and thus, an error may occur. That is, PHICH resource allocation for each layer is not defined. Accordingly, unless a DMRS-CS is newly defined with respect to the SU-MIMO, there may be a drawback in that all ACKs/NACKs of different layers are simultaneously mapped to a single PHICH resource.

When different PHICH resources are allocated by providing a predetermined offset to overcome the above drawback, a control area may be inefficiently used due to an increase of the PHICH resources.

A CA environment may also have the drawback, as the SU-MIMO. That is, in the CA, a plurality of UL CCs may be transmitted to a single DL CC. When each UE allocates a different PHICH resource and transmits an ACK/NACK, PHICH resources may be insufficient based on a CC configuration. Therefore, how a PHICH resource is mapped for each UL CC may need to be taken into consideration. Although a plurality of DL CCs exists, when all CCs excluding a single CC are extension carriers, a number of CCs that substantially transmit a PDCCH is one and thus, the error described in FIG. 2 may occur. When a number of layers or CCs that transmit data from a UE increases and a number of DL CCs is fewer than the number of layers or CCs, an error may occur in PHICH mapping.

According to an embodiment of the present invention, to overcome an error in the PHICH resource allocation that may occur in the UL SU-MIMO and an asymmetric CA where a plurality of UL CCs are linked to a single DL CC, a value of a field that is not changed during a predetermined period, for example, DMRS-CS 3 bits included in the DCI format 0 and the like may be utilized.

The DMRS-CS is information included in the DCI format 0, and may be semi-static information that is not changed during a predetermined period once it is set. That is, the DMRS-CS may not be changed during a predetermined period where communication is continued between a UE and an eNB. Also, although resource allocation is partially changed while the UE transmits a UL PUSCH, the 3-bit DMRS-CS may not be changed. Accordingly, a plurality of ACKs/NACKs may be multiplexed and stored in a single PHICH in the 3-bit DMRS-CS and thus, insufficiency of PHICH resources may be prevented.

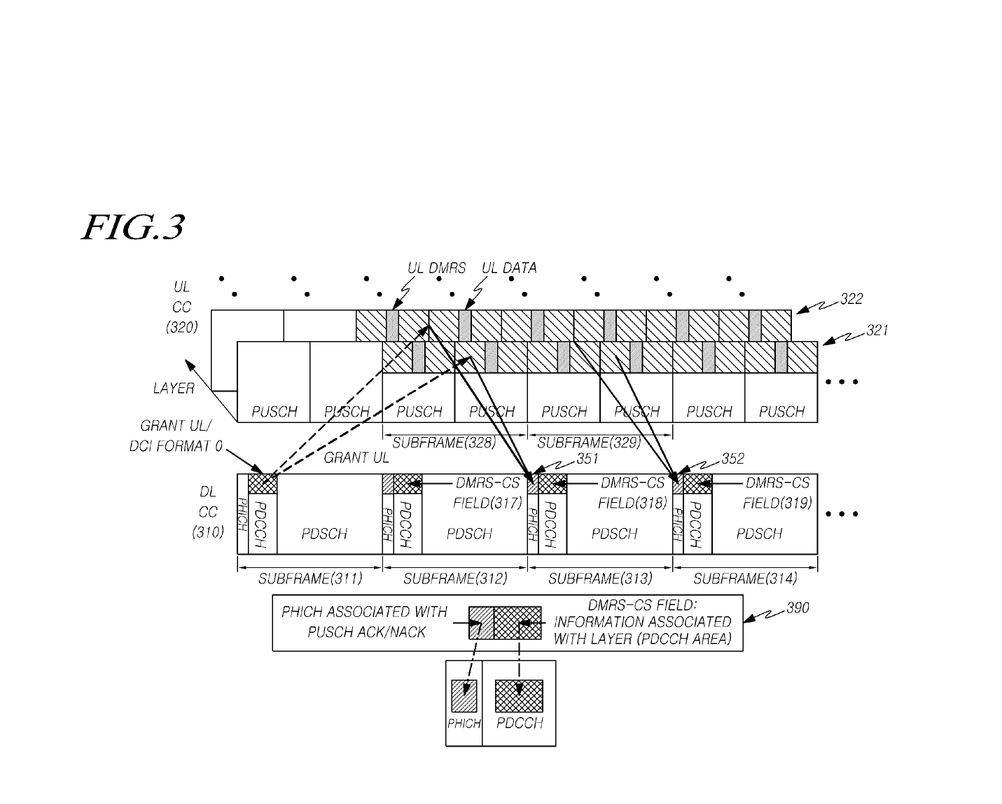

FIG. 3 illustrates a process that allocates PHICH resources in an SU-MIMO according to an embodiment of the present invention.

A DL CC 310 allocates resources to a UE, and a UL CC 320 transmits a plurality of pieces of independent data through a plurality of layers 321 and 322. A UL PUSCH resource (UL CC 320) may be allocated by a DCI format 0 that is included in a PDCCH of a subframe 311 that is transmitted from an eNB to the UE. In the process, 3-bit DMRS-CS information included in the DCI format 0 of the subframe 311 may be shared between the UE and the eNB.

When the UE performs communication by continuously using the same resource, the DCI format 0 may also be continuously transmitted through a PDCCH, and the UE may generate a UL DMRS based on the DMRS-CS that is first transmitted and may map the UL DMRS to a PUSCH of a subframe 328 and 329 for transmission, as shown in 390.

In the eNB, a PHICH is allocated based on a lowest PRB index of the received PUSCH and the 3-bit DMRS-CS and thus, a PHICH may also use the same resource (the same PHICH resources may be used) unless the lowest PRB index is changed.

Therefore, as illustrated in FIG. 3, the eNB may transmit ACK/NACK information to PHICH 351 and 352. Information associated with layers corresponding to the ACK/NACK transmitted through the PHICHs 351 and 352 may be multiplexed and included in 318 of the subframe 313 and 319 of the subframe 314. Each of 318 and 319 may be a DMRS-CS field included in a DCI format 0 transmitted through the same DL subframe, and the corresponding information may be shared between the eNB and the UE through the subframe 311 and thus, information associated with a layer corresponding to an ACK/NACK may be stored in the DMRS-CS area. Detailed configurations of the PHICH and the DMRS-CS field may be illustrated in 390.

In a section where the DMRS-CS is maintained, a DMRS-CS may not need to be transmitted separately and thus, the 3-bit DMRS-CS field may be used for distinguishing an ACK/NACK of a layer.

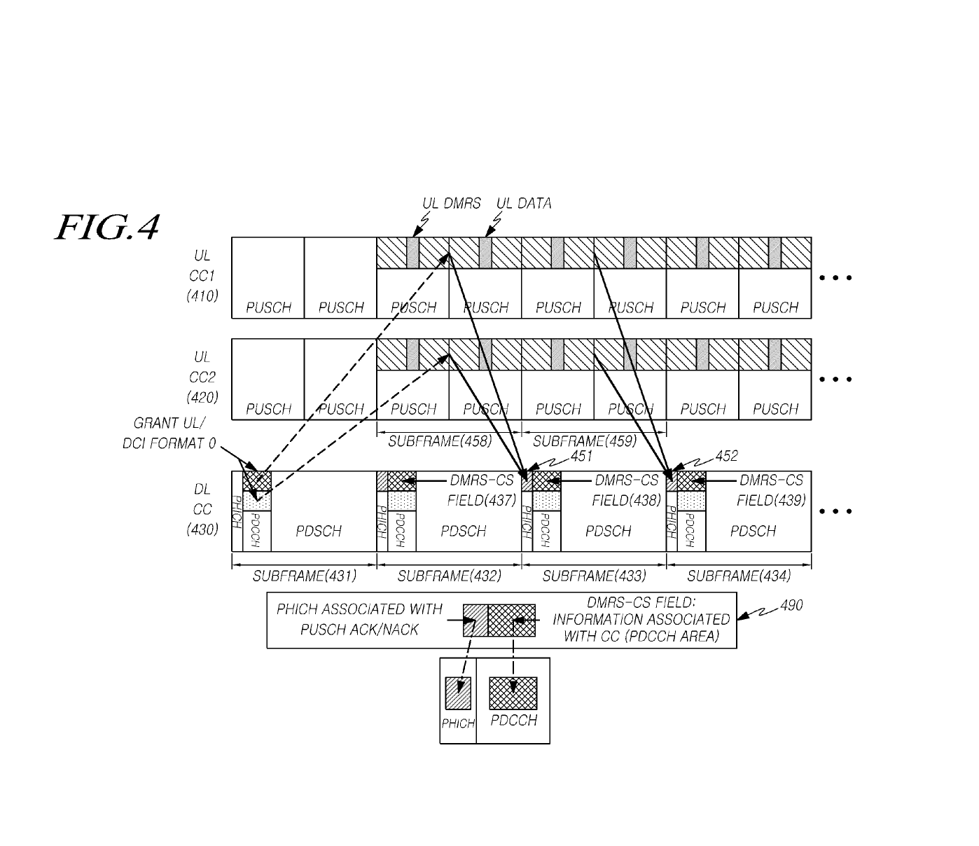

FIG. 4 illustrates a process that allocates PHICH resources in a CA according to an embodiment of the present invention. FIG. 4 shows a process that transmits ACKs/NACKs with respect to a plurality of UL CCs to a PHICH of a single DL CC in a CA environment. Two or more UL CCs 410 and a single DL CC 430 may exist.

A UE may determine a DCI format 0 of a PDCCH of a subframe 431 and may be assigned with UL CC resources 410 and 420. In the process, 3-bit DMRS-CS information included in the DCI format 0 of the subframe 431 may be shared between the UE and an eNB.

When the UE performs communication by continuously utilizing the same resources, the DCI format 0 associated with the CCs 410 and 420 may also be continuously transmitted through the PDCCH of the DL CC 430, and the UE may generate a UL DMRS based on the DMRS-CS that is transmitted first, and may map the DMRS to the PUSCH as shown in 458 and 459 for transmission.

In the eNB, a PHICH is allocated based on a lowest PRB index of the received PUSCH and the 3-bit DMRS-CS and thus, the PHICH may also use the same resource (the same PHICH resource may be used) unless the PRB index is changed.

Therefore, ACK/NACK information may be multiplexed and transmitted to the same PHICH 451 and 452. Also, information associated with a CC corresponding to an ACK/NACK transmitted through the PHICH 451 and 452 may be multiplexed and stored in a DMRS-CS field of a DCI format 0 transmitted through a DL subframe, such as 438 of the subframe 433 and 439 of the subframe 434. Detailed configurations of the PHICH and DMRS-CS field may be illustrated in 490.

In a section where the DMRS-CS is maintained, a DMRS-CS may not need to be transmitted separately and thus, the 3-bit DMRS-CS field may be used for distinguishing an ACK/NACK of a CC.

In FIGS. 3 and 4, a DMRS-CS field is not changed during a predetermined period and thus, a scheme that utilizes DMRS-CS 3 bits as indication information for an ACK/NACK has been described. In the process, to form indication information of the DMRS-CS field, it is taken into consideration that a PHICH transmits an ACK although a single ACK is generated from a layer or a CC. Also, the indication information may be formed in the opposite way.

When one or more ACKs are generated with respect to a transmitted PUSCH through a plurality of layers or CCs, the PHICH may transmit only an ACK, and information associated with a layer or a CC where an ACK is generated may be included in the DMRS-CS field. The UE may compare the DMRS-CS field transmitted through a subframe and may determine which layer or CC corresponds to the ACK information. When all multiplexed layers or UL CCs are NACKs, a NACK may be transmitted through the PHICH.

The scheme may be oppositely applied. Although a single NACK is generated, the NACK may be transmitted through the PHICH and information associated with a layer or a CC where the NACK is generated may be included in the DMRS-CS field. The UE may compare the transmitted DMRS-CS field so as to determine which layer or CC corresponds to the NACK information. When all multiplexed layers or UL CCs are ACKs, an ACK may be transmitted through the PHICH. An example in which the DMRS-CS field is used for distinguishing an ACK/NACK is shown in Table 2 and Table 3.

TABLE 2
when one or more ACKs are generated
and a PHICH transmits only an ACK

| 3-bit DMRS | Layer (based on | | |
|---|---|---|---|
| CS field | independent data | | |
| (B₀B₁B₂) | transmission) | UL CC | Note |
| B₀ | Information on | Information | ACK information |
| | whether Layer 1 | on whether UL | of up to 3 layers |
| | ACK exists | CC-1 ACK | or CCs is |
| | | exists | simultaneously |
| B₁ | Information on | Information | multiplexed |
| | whether Layer 2 | on whether UL | |
| | ACK exists | CC-2 ACK | |
| | | exists | |
| B₂ | Information on | Information | |
| | whether Layer 3 | on whether UL | |
| | ACK exists | CC-3 ACK | |
| | | exists | |

TABLE 3
when one or more NACKs are generated
and a PHICH transmits only a NACK

| 3-bit DMRS | Layer (based on | | |
|---|---|---|---|
| CS field | independent data | | |
| (B₀B₁B₂) | transmission) | UL CC | Note |
| B₀ | Information on | Information | NACK information |
| | whether Layer 1 | on whether UL | of up to 3 layers |
| | NACK exists | CC-1 NACK | or CCs is |
| | | exists | simultaneously |
| B₁ | Information on | Information | multiplexed |
| | whether Layer 2 | on whether UL | |
| | NACK exists | CC-2 NACK | |
| | | exists | |
| B₂ | Information on | Information | |
| | whether Layer 3 | on whether UL | |
| | NACK exists | CC-3 NACK | |
| | | exists | |

When the eNB transmits representative response data, that is, an ACK or a NACK to a PHICH, and information associated with whether a layer or a UL CC corresponds to the representative response data is stored in 3 bits and may be transmitted to a UE, the UE may determine whether data of the layer/UL CC is correctly transmitted and whether an error occurs in the data of the layer/UL CC. The UE may retransmit the portion where the error occurs.

In Table 2, information indicating whether a UL layer or a UL CC corresponding to each field is an ACK may be included. That is, when it is the ACK, a verification result on data transmission in the corresponding UL layer or the UL CC is the ACK. However, when it is is different from the ACK, it may indicate a NACK or may indicate that the eNB fails to receive information through the corresponding UL layer/CC. In Table 3, information indicating whether a UL layer or a UL CC corresponding to each field is a NACK may be included. That is, when it is the NACK, a verification result on data transmission in the corresponding UL layer or the UL CC is the NACK. When it is different from the NACK, it may indicate the ACK or may indicate that the eNB fails to receive information through the corresponding UL layer/CC. A layer or a UL CC that does not correspond to the ACK in Table 2 is not always the NACK, and a layer or a UL CC that does not correspond to the NACK in Table 2 is not always the ACK.

In particular, although data is transmitted through layer 2 (or UL CC 2) based on Table 2, and a value that is different from the ACK is received, the eNB may receive information and may determine the NACK since an error exists, or the eNB may fail to receive the information since an error occurs during transmission. In the same manner, although data is transmitted through layer 2 (or UL CC2) based on Table 3, and a value that is different from the NACK is received, the eNB may correctly receive the information and determine the ACK, or may fail to receive the information since an error occurs during transmission.

In FIGS. 3 and 4, a DMRS-CS field may be used as PHICH indication information in an SU-MIMO or an asymmetric CCA environment, since the DMRS-CS is not changed during a predetermined period. However, after the predetermined period, the DMRS-CS shared between the eNB and the UE may need to be updated. A scheme of updating the DMRS-CS may include 1) updating the DMRS-CS based on a number of subframes through a PUSCH, 2) updating the DMRS-CS by setting a timer for a predetermined period of time, and 3) updating the DMRS-CS through use of a dedicated signaling and the eNB informs the UE of the update of the DMRS-CS through a dedicated signaling.

According to an embodiment of the present invention, in FIGS. 3 and 4, representative response data among response data may be determined to be first information, and information associated with whether each layer or each CC corresponds to the response data may be determined to be second information. The first information may be stored in a first section (PHICH) of a control area and the second information may be stored in the DMRS-CS, that is, a field that is not changed during a predetermined period and belongs to a second section (PDCCH) of the control area.

In Tables 2 and 3, matching of 3-bit information is performed for each layer or for each CC. However, the allocation may be changed based on a way that embodies the invention. 8 (2³) pieces of information may be represented by 3 bits and thus, whether a CC or a layer corresponds to an ACK or NACK may be matched to the values. A plurality of CCs or layers may be bound to match a single field or a new value may be assigned to 3 bits so as to determine whether each CC or each layer corresponds to an ACK or a NACK based on the corresponding value. In this example, a number of CCs or layers may not be limited to 3, and may be extended to 4, 5, and the like. An embodiment and another embodiment that indicate ACK or NACK information of a CC or a layer for each predetermined bit, may include an architecture that determines a layer or a CC having an ACK/NACK value based on a predetermined value of 3 bits, as shown in Table 4 and Table 5. The matching value may be shared between the eNB and the UE through an upper layer signaling. For example, a predetermined bit does not match a predetermined layer/CC, but which layer or CC corresponds to response data that is transmitted through a PHICH may be determined based on the entire 3-bit value.

TABLE 4
when one or more ACKs are generated and a PHICH
transmits only an ACK (second embodiment)

| 3-bit DMRS- | Layer (based on | |
|---|---|---|
| CS field | independent data | |
| (B₀B₁B₂) | transmission) | UL CC |
| 000 | Layers 1, 2, and 3 | UL CC-1, 2, and 3 |
| | correspond to ACK | correspond to ACK |
| 001 | Layers 1 and 2 | UL CC-1 and 2 |
| | correspond to ACK | correspond to ACK |
| 010 | Layers 1 and 3 | UL CC-1 and 3 |
| | correspond to ACK | correspond to ACK |
| 011 | Layers 2 and 3 | UL CC-2 and 3 |
| | correspond to ACK | correspond to ACK |
| 100 | Layer 1 corresponds | UL CC-1 corresponds |
| | to ACK | to ACK |
| 101 | Layer 2 corresponds | UL CC-2 corresponds |
| | to ACK | to ACK |
| 110 | Layer 3 corresponds | UL CC-3 corresponds |
| | to ACK | to ACK |
| 111 | Layers 1, 2, and 3 do not | UL CC-1, 2, and 3 do |
| | correspond to ACK | not correspond to ACK |

TABLE 5
when one or more NACKs are generated a PHICH
transmits only a NACK (second embodiment)

| 3-bit DMRS- | Layer (based on | |
|---|---|---|
| CS field | independent data | |
| (B₀B₁B₂) | transmission) | UL CC |
| 000 | Layers 1, 2, and 3 | UL CC-1, 2, and 3 |
| | correspond to NACK | correspond to NACK |
| 001 | Layers 1 and 2 | UL CC-1 and 2 |
| | correspond to NACK | correspond to NACK |
| 010 | Layers 1 and 3 | UL CC-1 and 3 |
| | correspond to NACK | correspond to NACK |
| 011 | Layers 2 and 3 | UL CC-2 and 3 |
| | correspond to NACK | correspond to NACK |
| 100 | Layer 1 corresponds | UL CC-1 corresponds |
| | to NACK | to NACK |
| 101 | Layer 2 corresponds | UL CC-2 corresponds |
| | to NACK | to NACK |
| 110 | Layer 3 corresponds | UL CC-3 corresponds |
| | to NACK | to NACK |
| 111 | Layers 1, 2, and 3 do not | UL CC-1, 2, and 3 do |
| | correspond to NACK | not correspond to NACK |

In the same manner as Tables 2 and 3, in Tables 4 and 5, whether a UL layer or a CC corresponds to an ACK (Table 4) or a NACK (Table 5) may be determined, based on a value of 3 bits. Here, when a layer or a UL CC does not correspond to the ACK or NACK, it does not indicate that the corresponding layer or the corresponding UL CC corresponds to an opposite value. As described in the foregoing, a layer or a UL CC that does not correspond to the ACK in Table 4 may not always be the NACK, and a layer or a UL CC that does not correspond to the NACK in Table 5 may not always be the ACK, as described in Tables 2 and 3.

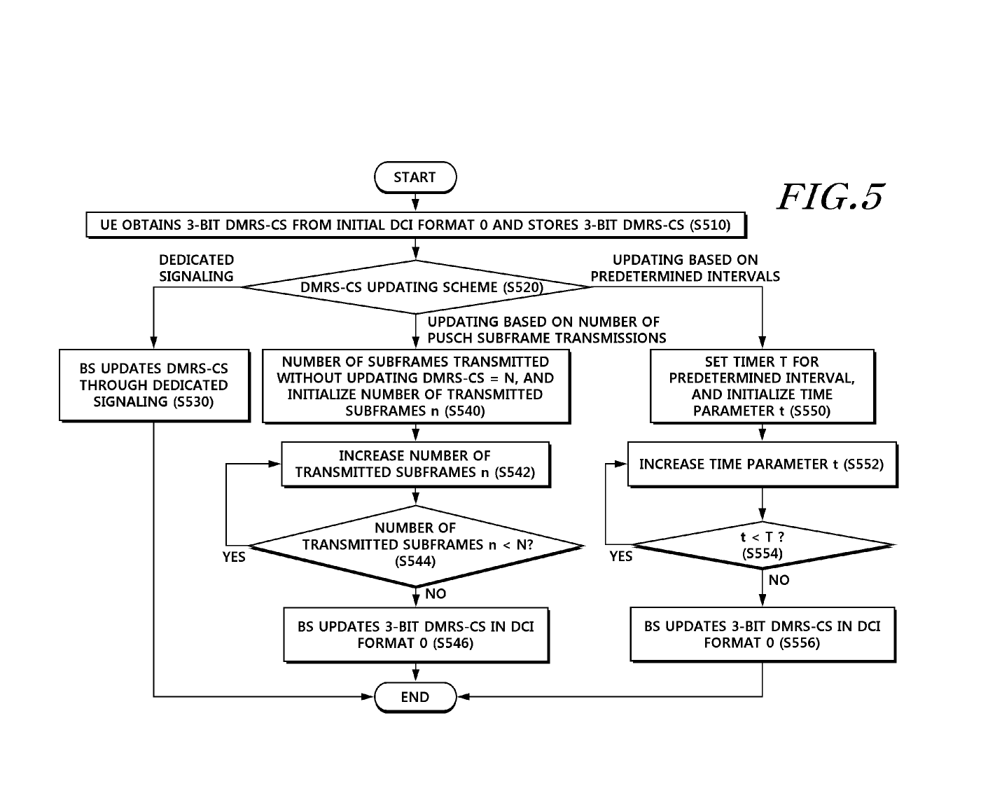

FIG. 5 illustrates a process that updates a DMRS-CS according to an embodiment of the present invention. In an embodiment of the present invention, it has been described that response data is included in a DMRS-CS that is one of the examples of a field that is not changed during a predetermined period. Therefore, a process that updates a value of the DMRS-CS which is changed after the predetermined period may be required. This may also be applied to another field that is not changed during a predetermined period. In FIG. 5, a scheme in which an BS updates the DMRS-CS may include i) updating the DMRS-CS based on a dedicated updating signaling, ii) updating the DMRS-CS when a number of subframes transmitted through a PUSCH is greater than or equal to a predetermined number of subframes, and iii) updating the DMRS-CS by setting a timer for a predetermined period of time. First, when the BS transmits a PDCCH including DMRS-CS information of a DCI format 0 to a UE, the UE and the BS may share the DMRS-CS information. The UE may obtain the DMRS-CS from the DCI format 0, and may store the DMRS-CS (step S510). The BS may update the DMRS-CS when a predetermined condition is satisfied based on a DMRS-CS updating scheme (step S520). An updating process may be performed (steps S530 through S556). First, the BS may perform updating based on a dedicated signaling (step S530). When an updating scheme corresponds to updating based on a number of PUSCH subframe transmissions, a number of subframes transmitted without updating the DMRS-CS to N, and a number of transmitted subframes n may be initialized (step S540). The number of subframes n may be increased based on the PUSCH transmission (step S542). When the number of transmitted subframes n is less than N (step S544), step S542 may be performed since it is not an appropriate time for updating the DMRS-CS. When the number of transmitted subframes n reaches N, the 3-bit DMRS-CS may be updated in the DCI format 0 (step S546).

When the DMRS-CS updating scheme corresponds to updating based on predetermined time intervals in step S520, a timer T may be set for the predetermined period of time, and a time parameter t may be initialized (step S550). Over time, the time timer t may be increased (step S552). When the timer t is less than T (step S554), step S552 may be performed since it is not an appropriate time for updating the DMRS-CS. When t reaches T after a predetermined time, the 3-bit DMRS-CS may be updated in the DCI format 0 (step S556).

The updated DMRS-CS may be transmitted from the BS to the UE, and the UE may obtain and store new DMRS-CS information.

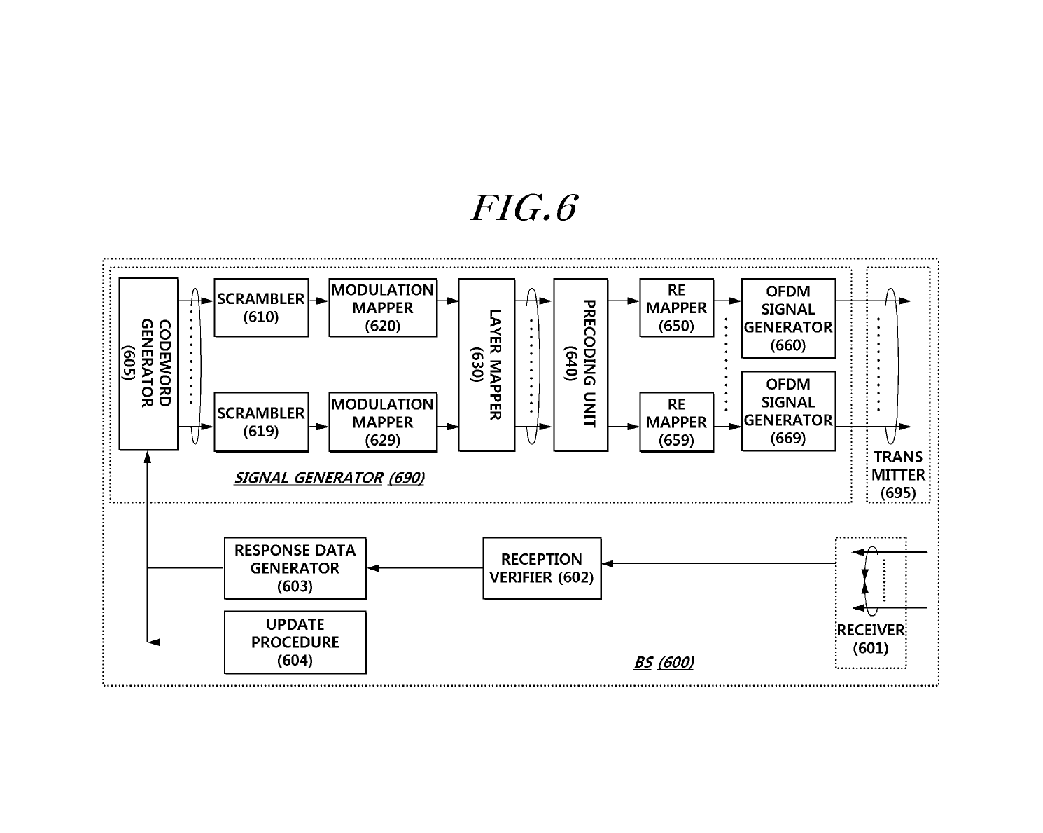

FIG. 6 illustrates a configuration of a BS according to an embodiment of the present invention. An eNB or a BS 600 may be configured to include a signal generator 690 to generate a wireless signal, a transmitter 695 to transmit the generated signal, and a receiver 601 to receive data. To embody an embodiment of the present invention, the BS may further include a reception verifier 602 to verify received data or a subframe, a response data generator 603 to transmit an ACK/NACK corresponding to a verification result on a plurality of subframes received in a multiple layers environment or a multiple CCs environment, and an update procedure 604 to update a field that is not changed during a predetermined period, such as a DMRS-CS field. The component elements may be configured as a single module, or may be configured as separate modules to perform respective functions, or may be embodied by two or more separate modules.

The receiver 601 may receive two or more UL subframes including independent data from a user terminal, such as a UE. The subframe may indicate a basic unit of data transmission and reception, and may not be limited to the name of the subframe used in a predetermined communication protocol. Two or more UL subframes may be received through a plurality of layers in an SU-MIMO environment as described in FIGS. 3 and 4, and may be received through a plurality of UL CCs in a CA environment.

The subframe received by the receiver 601 may include data such as a PUSCH. The reception verifier 602 may verify whether an error exists in the received data, and may generate response data including a plurality of verification results on a plurality of UL subframes. The response data may be generated to be an ACK/NACK for each layer or for each CC. Also, ACK/NACK information and information associated with which layer or CC corresponds to an ACK or a NACK may be included as described in Table 2 and Table 3. The signal generator 690 may generate a DL subframe in which a portion or all of the response data is stored in a field that is not changed during a predetermined period and belongs to a control area. When the response data is divided in to first information and second information, and the entire control area is divided into a first section and a second section, the first information may be stored in the first section of the control area and the second information may be stored in the second section. In particular, the first information of the response data may be representative response data such as an ACK/NACK, and the second information may indicate information on whether each layer and each CC corresponds to an ACK or a NACK. The first and second information may be stored in the first section and the second section of the control area, respectively. The first section and the second section of the control area may correspond to, for example, a PHICH (an example of the first section) and a PDCCH (an example of the second section), respectively. A process of generating a DL subframe may generate a portion or all of the response data to be stored in a field that is not changed during a predetermined period (for example, a DMRS-CS field), such as 351, 352, 451, and 452 of FIGS. 3 and 4. As described in the foregoing, whether three types of layers or UL CCs correspond to an ACK/NACK may be stored in a 3-bit DMRS-CS field. Also, a portion or all of the response data may be stored in a field that is not changed during a predetermined period that is different from the DMRS-CS in is the PDCCH area (the second section) of the control area. The transmitter 695 may transmit the DL subframe generated by the signal generator 690. The portion of the response data may be information to identify two or more UL subframes transmitted through different layers or CCs, which is shown in Table 2 and Table 3.

The BS may generate and transmit information required for allocating resources to a corresponding UE, before receiving data from the UE. The signal generator 690 may store resource allocation information for a UL subframe of a UE in a resource allocation control area (for example, a PDCCH corresponding to the second section), and may store information (for example, a DMRS-CS) associated with a reference signal to be included in the UL subframe in a field that is not changed during a predetermined period and belongs to the resource allocation control area. The information such as the DMRS-CS is not changed during a predetermined period after it is set and thus, a portion or all of response data including a verification result on a subframe received from the UE may be stored in a DMRS-CS field for transmission.

According to a detailed configuration of the signal generator 690, a codeword generator 605 may generate information associated with the response data as a codeword, and the generated codeword may be scrambled by scramblers 610 through 619. The blocks of scrambled bits may be modulated to be a symbol by modulation mappers 620 through 629 based on a predetermined modulation scheme. The modulation may include biphase shift keying (BPSK), quadrature phase shift keying (QPSK), and the like. In a case of a PDCCH including a portion of the response data, modulation may be performed through the QPSK. Also, in a case of a PHICH including the other portion of the response data, modulation may be performed through the BPSK.

The symbol may be mapped to various layers by a layer mapper 630. In this process, when a single antenna port is used for transmission, the symbol may be mapped to a single layer for transmission. Conversely, when a plurality of antenna ports is used for transmission, a multi-antenna transmission scheme may be used. The layer mapping may be performed through use of the multi-antenna transmission scheme such as a spatial multiplexing or a transmit diversity.

When the layer mapping is completed, a precoding unit 640 may generate a vector block so that mapping is performed on resources based on a mapping scheme of an antenna port. A precoding scheme may be determined based on a number of antennas determined by the layer mapping and a multi-antenna mapping scheme.

When the precoding is completed, resource element (RE) mappers 650 through 659 may perform mapping with respect to REs. When the mapping is completed, OFDMs generated by the OFDM signal generator 660 through 669 may be transmitted through an antenna port of a transmitter 695.

The various component elements in the signal generator 690 may function as a single module or may function as various sub-modules. Also, a predetermined module may be excluded based on a feature of a communication protocol, or a module required for the communication protocol may be added separately.

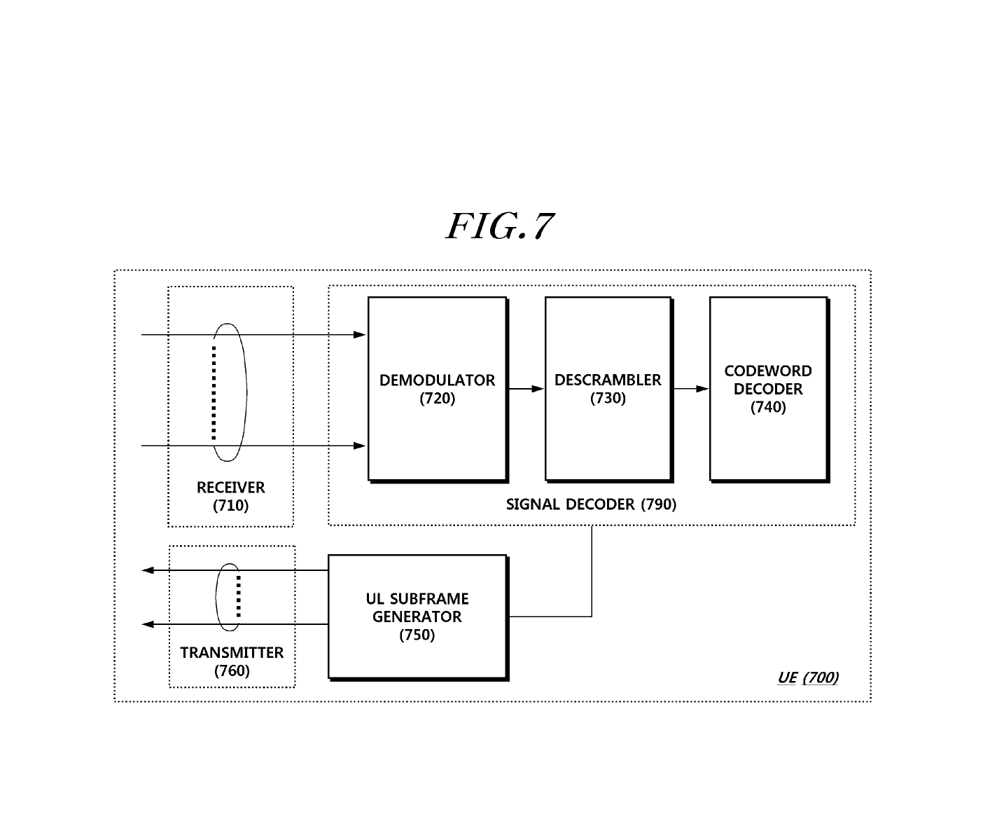

FIG. 7 illustrates a configuration of a UE according to an embodiment of the present invention.

A UE 700 may be configured to include a receiver 710 to receive a subframe from a BS, a signal decoder 790 to decode the received signal to extract information, a UL subframe generator to generate information to be transmitted as a subframe, and a transmitter 760 to transmit the generated subframe.

The receiver 710 may receive a DL subframe including information associated with UL resource allocation from the BS, and the signal decoder 790 may extract UL resource allocation information from the received DL subframe. The UL subframe generator 750 may generate a UL subframe based on the extracted UL resource allocation information, and the transmitter 760 may transmit two or more UL subframes including independent data to the BS through use of the allocated UL resources. The transmitter 760 may transmit the UL subframe based on an SU-MIMO scheme through two or more layers, or through two or more CCs in a CA environment.

When the receiver 710 receives a DL subframe including response data corresponding to a verification result on the transmitted UL subframe, the signal decoder 790 may determine a transmission result of the UL subframe by extracting the response data from a control area of the DL subframe and from a field that is not changed during a predetermined period and belongs to the control area. When the response data is divided into first information and second information, and the entire control area is divided into a first section and a second section, the first information may be stored in the first section of the control area and the second information may be stored in the second section. In particular, the first information of the response data may be representative response data such as an ACK/NACK, and the second information may indicate whether each layer or each CC corresponds to an ACK/NACK. The first and second information may be stored in the first section and the second section of the control area, respectively. The response data may be included in, for example, a PHICH (an example of the first section) and a PDCCH (an example of the second section), and the field that is not changed during the predetermined period may be a field included in the PDCCH. In particular, the field may be a field including information to set a cyclic shift of a DMRS of the UE.

As described in FIGS. 3 and 4, a DMRS-CS field may be information that is not changed during a predetermined period, since a DMRS-CS may be used during a predetermined period when the DMRS-CS is shared between the BS and the UE in a UL resource allocation process. When a UL is started, the UL subframe generator 750 may insert a reference signal (DMRS) into the UL subframe based on the information (DMRS-CS) associated with the reference signal. The receiver 710 may receive, from the BS, a DMRS-CS field including a portion or all of response data including a verification result on a subsequence UL subframe.

When the transmitted response data is configured as shown in Table 2 and Table 3, representative response data (ACK/NACK) may be included in a PHICH, and information associated with a UL subframe corresponding to the representative response data may be included in the DMRS-CS. Accordingly, the signal decoder 790 may extract the information associated with the UL subframe corresponding to the representative response data from the DMRS-CS field that is not changed during a predetermined period, and determine information associated with a subframe that requires retransmission. The corresponding subframe may be retransmitted through the transmitter 760.

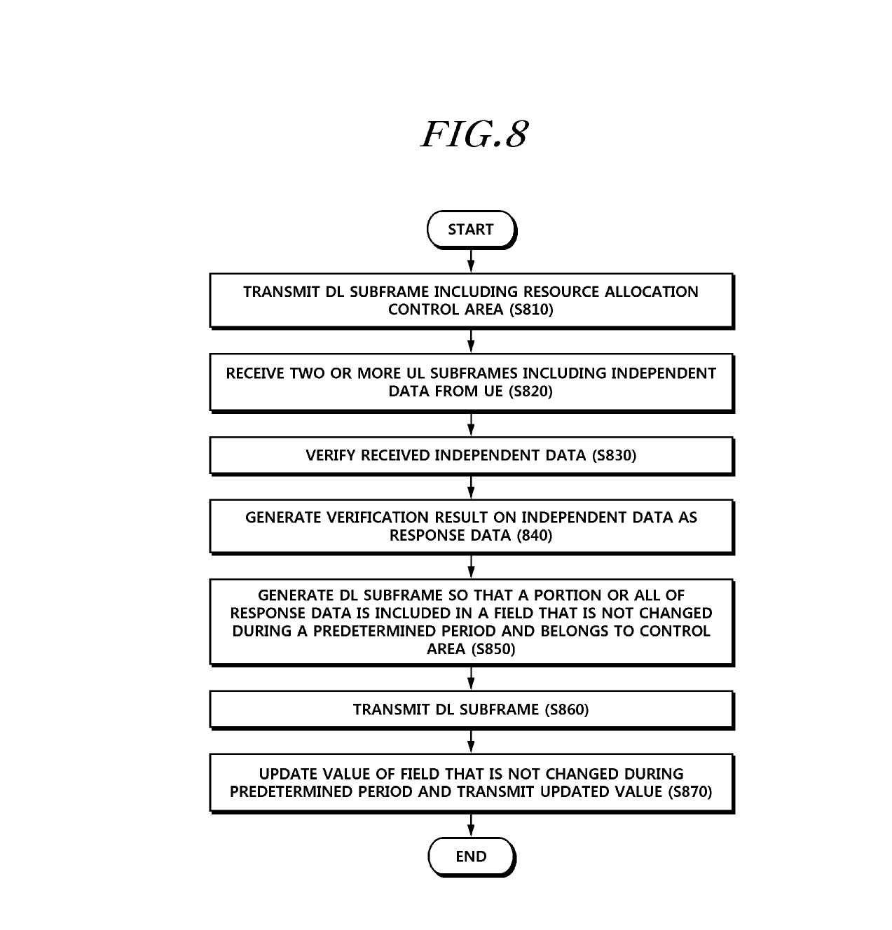

FIG. 8 illustrates a process that transmits and receives data in a BS according to an embodiment of the present invention.

A BS may transmit a DL subframe including resource allocation control area so as to allocate resources to a UE (step S810). To transmit the DL subframe, the BS may store, in the resource allocation control area of the DL subframe, resource allocation information for a UL subframe to be transmitted by the UE, and may store information associated with a reference signal to be included in the UL subframe in a field that is not changed during a predetermined period and that belongs to the resource allocation control area. The control area may be a PDCCH, and the field that is not changed during the predetermined period may be a cyclic shift field of a DMRS of the UE.

Also, two or more UL subframes including independent data may be received from the UE that is assigned with resources (step S820). Two or more UL subframes may be received based on an SU-MIMO scheme through two or more layers, or may be received through two or more CCs in a CA.

The BS may verify received independent data (step S830). A verification result on the independent data may be generated as response data (step S840). According to a scheme of generating the response data as described in FIG. 6, the response data may be divided into first information and second information, a control area may be divided into a first section and a second section, and the first information of the response data, that is, an ACK or a NACK, may be included in a PHICH which is an example of the first section. Also, representative response data corresponding to the first information of the response data and multiplexing information corresponding to the second information may be distinguished from each other, and when at least one ACK (or a NACK) exists in a layer/CC, the ACK (or the NACK) may be the representative data, and information associated with a layer/CC corresponding to the representative response data may be the multiplexing information. The DL subframe may be generated so that the representative response data may be stored in the control area (a PHICH corresponding to the first section), and the multiplexing information corresponding to the second information, which is a portion of the response data, may be stored in a field that is not changed during a predetermined period and belongs to the second section (step S850). As described in the foregoing, a portion of the response data may be information to identify two or more UL subframes transmitted through different layers or CCs, which is shown in Table 2 and Table 3. Also, a DMRS-CS field may be an example of the field that is not changed during the predetermined period. Also, the generated DL subframe may be transmitted to the UE (step S860).

A value of the field that is not changed may be updated and transmitted based on predetermined intervals or based on predetermined condition (step S870). An updating scheme has been described with reference to FIG. 5.

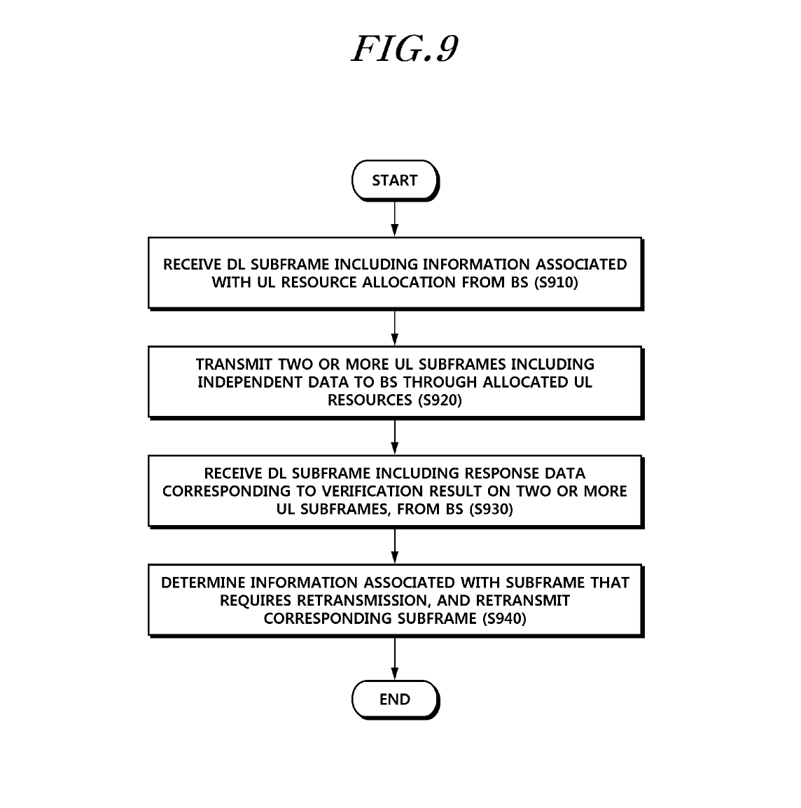

FIG. 9 illustrates a process that transmits and receives data in a UE according to an embodiment of the present invention.

The UE may receive a DL subframe including information associated with UL resource allocation from a BS (step S910). The information associated with the UL resource allocation corresponding to resource allocation information for an UL subframe, included in the DL subframe may be stored in a resource allocation control area, and information (for example, a DMRS-CS) associated with a reference signal to be included in the UL subframe may be stored in a field that is not changed during a predetermined period and that belongs to the resource allocation control area.

Two or more UL subframes including independent data may be transmitted to the BS through the allocated UL resources (step S920). In this example, a reference signal may be inserted into the UL subframe based on the information associated with the reference signal received in step S910. The two or more UL subframes may be transmitted through two or more layers based on an SU-MIMO scheme, and may be transmitted through two or more CCs in a CA.

A DL subframe including response data corresponding to a verification result on is the two or more UL subframes may be received from the BS (step S930). The response data corresponding to the verification result may be included in the control area, and examples of the control area may include a PHICH and a PDCCH. As described in FIG. 7, the response data may be divided into first information and second information, the control area may be divided into a first section and a second section, and an ACK or a NACK corresponding to representative response data, which is an example of the first information, may be extracted from the PHICH which is an example of the first section. The second information of the response data (for example, multiplexing information) may be stored in a field that is not changed during a predetermined period and that belongs to the second section of the control area of the DL subframe and thus, information associated with a subframe that requires retransmission may be determined by extracting the value and the corresponding subframe may be retransmitted (step S940). The field may be an area where information to set a DMRS-CS of the UE is stored, and may correspond to the field that is not changed during the predetermined period after it is set in step S910, as described in the foregoing. Also, when DMRS-CS information is updated as shown in FIG. 5, the DMRS-CS information may be received from the BS.

When an embodiment of the present invention is embodied, resources of the control area, such as a PHICH and a PDCCH, may be effectively used. That is, a plurality of ACKs/NACKs may be unitarily transmitted, and a field in an existing control area may be used without additionally allocating limited PHICH resources.

In particular, the PHICH resources may be limited by a bandwidth and a parameter transmitted from an upper layer and thus, when a plurality of UEs transmit subframes through a plurality of layers or through a plurality of CCs in an asymmetric CCA and an ACK/NACK is transmitted for each layer/CC, the PHICH resources may become insufficient based on a communication state. Accordingly, an efficiency of the control area may be deteriorated. Therefore, according to an embodiment of the present invention, an efficiency of a network may be improved since a control area may not be additionally extended during a process of transmitting a plurality of ACKs/NACKs.

Although exemplary embodiments of the present invention have been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

1. A base station (BS), comprising:
a receiver to receive, by the BS from a user equipment (UE), two or more uplink (UL) subframes including independent data;
a reception verifier to verify the independent data received by the receiver;
a response data generator to generate a verification result on the independent data as response data;
a signal generator to store first information of the response data in a first section in a control area, and to store second information of the response data in a field that is not changed during a predetermined period and belongs to a second section that is distinguished from the first section in the control area, so as to generate a downlink (DL) subframe; and
a transmitter to transmit the DL subframe.

2. The BS as claimed in claim 1, wherein the first section of the control area is a physical hybrid ARQ indicator channel (PHICH), the second section is a physical downlink control channel (PDCCH), and the field that is not changed during the predetermined period is information to set a demodulation reference signal cyclic shift (DMRS-CS) of the UE.

3. The BS as claimed in claim 2, wherein the first information of the response data that is stored in the first section is one of an acknowledgement (ACK) and a negative acknowledgement (NACK), which are representative response data of the verification result on the two or more UL subframes.

4. The BS as claimed in claim 1, wherein the second information of the response data that is stored in the field that is not changed during the predetermined period and belongs to the second section is information indicating whether the verification result on the two or more UL subframes corresponds to the first information.

5. The BS as claimed in claim 1, wherein the receiver receives the two or more UL subframes based on a single-user multiple input multiple output (SU-MIMO) scheme through two or more layers, or receives the two or more UL subframes through two or more component carriers (CCs) in a carrier aggregation (CA).

6. The BS as claimed in claim 1, wherein the signal generator stores resource allocation information for a UL subframe of the UE in the second section, and stores information associated with a reference signal to be included in the UL subframe in the field that is not changed during the predetermined period and belongs to the second section.

7. The BS as claimed in claim 1, further comprising:
an update procedure to update a value of the field that is not changed during the predetermined period and belongs to the second section.

8. A user equipment (UE), comprising:
a receiver to receive, from a base station (BS), a downlink (DL) subframe including information associated with uplink (UL) resource allocation;
a signal decoder to extract the uplink resource allocation information from the received DL subframe;
a UL subframe generator to generate a UL subframe based on the UL resource allocation information; and
a transmitter to transmit, to the BS, two or more UL subframes including independent data through the allocated uplink resource,
wherein the receiver receives, from the BS, a DL subframe including response data corresponding to a verification result on the two or more UL subframes; and
the signal decoder extracts first information of the response data from a first section of a control area of the DL subframe, and extracts second information of the response data from a field that is not changed during a predetermined period and belongs to a second section that is distinguished from the first section in the control area.

9. The UE as claimed in claim 8, wherein the information associated with the UL resource allocation is resource allocation information for the UL subframe that is stored in the second section;
information associated with a reference signal to be included in the UL subframe is stored in the field that is not changed during the predetermined period and belongs to the second section; and
the UL subframe generator inserts, into the UL subframe, a reference signal generated based on the information associated with the reference signal.

10. The UE as claimed in claim 8, wherein the first section of the control area is a physical hybrid ARQ indicator channel (PHICH), the second section is a physical downlink control channel (PDCCH), and the field that is not changed during the predetermined period is information to set a demodulation reference signal cyclic shift (DMRS-CS) of the UE.

11. The UE as claimed in claim 10, wherein the first information of the response data that is stored in the first section is one of an acknowledgement (ACK) and a negative acknowledgement (NACK), which are representative response data of the verification result on the two or more subframes.

12. The UE as claimed in claim 8, wherein the second information of the response data that is stored in the field that is not changed during the predetermined period and belongs to the second section is information indicating whether the verification result on the two or more UL subframes corresponds to the first information.

13. The UE as claimed in claim 8, wherein the transmitter transmits the two or more UL subframes based on a single-user multiple input multiple output (SU-MIMO) scheme through two or more layers, or transmits the two or more UL subframes through two or more component carriers (CCs) in a carrier aggregation (CA).

14. The UE as claimed in claim 8, wherein a representative value of the response data corresponding to the verification result on the two or more UL subframes is the first information; and
the signal decoder extracts second information corresponding to information associated with a UL subframe corresponding to the first information from the field that is not changed during the predetermined period, determines information associated with a subframe that requires retransmission based on the first information and the second information, and retransmits the subframe that requires retransmission.

15. A method of performing multiple transmission of a data transmission result, the method comprising:
receiving, from a user equipment (UE), two or more uplink (UL) subframes including independent data, and verifying the independent data;
generating a verification result on the independent data as response data, storing first information of the response data in a first section of a control area, and storing second information of the response data in a field that is not changed during a predetermined period and belongs to a second section that is distinguished from the first section in the control area, so as to generate a downlink (DL) subframe; and
transmitting the DL subframe.

16. The method as claimed in claim 15, wherein the first section of the control area is a physical hybrid ARQ indicator channel (PHICH), the second is a physical downlink control channel (PDCCH), and the field that is not changed for the predetermined period is information to set a demodulation reference signal cyclic shift (DMRS-CS) of the UE.

17. The method as claimed in claim 16, wherein the first information of the response data that is stored in the first section is one of an acknowledgement (ACK) and a negative acknowledgement (NACK), which are representative response data of the verification result on the two or more UL subframes.

18. The method as claimed in claim 15, wherein the second information of the response data that is stored in the field that is not changed during the predetermined period and belongs to the second section is information indicating whether the verification result on the two or more UL subframes corresponds to the first information.

19. The method as claimed in claim 15, wherein the two or more UL subframes are received based on a single-user multiple input multiple output (SU-MIMO) through two or more layers, or the two or more UL subframes are received through two or more component carriers (CCs) in a carrier aggregation (CA).

20. The method as claimed in claim 15, wherein, before verifying, the method comprises:
storing, in the second section, resource allocation information for a UL subframe of the UE; and
storing information associated with a reference signal to be included in the UL subframe, in the field that is not changed during the predetermined period and belongs to the second section, and transmitting a downlink (DL) subframe including the first section and the second section.

21. The method as claimed in claim 15, further comprising:
updating a value of the field that is not changed during the predetermined period and belongs to the second section and transmitting the value.

22. A method of performing multiple reception of a data transmission result, the method comprising:
receiving, from a base station (BS), a downlink (DL) subframe including information associated with uplink (UL) resource allocation;
transmitting, to the BS, two or more UL subframes including independent data through use of the allocated UL resources;
receiving, from the BS, a DL subframe including response data corresponding to a verification result on the two or more UL subframes; and
extracting first information of the response data from a first section of a control area of the received DL subframe, and extracting second information of the response data from a field that is not changed during a predetermined period and belongs to a second section that is distinguished from the first section.

23. The method as claimed in claim 22, wherein the information associated with the UL resource allocation is resource allocation information for a UL subframe that is stored in the second section; and
information associated with a reference signal to be included in the UL subframe is stored in the field that is not changed during the predetermined period and belongs to the second section,
wherein the method further comprises generating a reference signal based on the information associated with the reference signal after extracting, and inserting the reference signal into the UL subframe.

24. The method as claimed in claim 22, wherein a first section of the control area is a physical hybrid ARQ indicator channel (PHICH), a second section is a physical downlink control channel (PDCCH), and the field that is not changed is information to set a DMRSCS of the UE.

25. The method as claimed in claim 24, wherein the first information of the response data that is stored in the first section is one of an acknowledgement (ACK) and a negative acknowledgement (NACK) of a HARQ, which are representative response data of the verification result on the two or more UL subframes.

26. The method as claimed in claim 22, wherein the second information of the response data that is stored in the field that is not changed during the predetermined period and belongs to the second section is information indicating whether the verification result on the two or more UL subframes corresponds to the first information.

27. The method as claimed in claim 22, wherein transmitting of the UL subframe through use of the allocated UL resources comprises:
transmitting two or more UL subframes based on a single-user multiple input multiple output (SU-MIMO) scheme through two or more layers, or transmitting two or more UL subframes through two or more component carriers (CCs) in a carrier aggregation (CA).

28. The method as claimed in claim 22, wherein a representative value of the response data, received from the BS, corresponding to the verification result on the two or more UL subframes is first information;
extracting further comprises extracting the second information corresponding to information associated with a UL subframe corresponding to the first information from the field that is not changed during the predetermined period; and
the method further comprises determining information associated with a subframe requires retransmission, based on the first information and the second information, and retransmitting the corresponding subframe.
